(19) United States
(12) Patent Application Publication
(10) Pub. No.: US 2015/0371345 A1
(43) Pub. Date: Dec. 24, 2015

(54) System, Method and Computer Program Product for Predicting Well Production

(71) Applicant: LANDMARK GRAPHICS CORPORATION, Houston, TX (US)

(72) Inventor: TRAVIS LEE JEFFERS, Katy, TX (US)

(73) Assignee: Landmark Graphics Corporation, Houston, TX (US)

(21) Appl. No.: 14/768,005

(22) PCT Filed: Mar. 25, 2013
(86) PCT No.: PCT/US2013/033690

§ 371 Date: Aug. 14, 2015

(51) Int. Cl. G06Q 50/02; G06Q 10/06; G06Q 10/04; E21B 47/00

(52) U.S. Cl. CPC G06Q 50/02; E21B 47/00; G06Q 10/06315; G06Q 10/04

(57) ABSTRACT

A system and method that analyzes well property data and historical production data in order to predict future well production and/or to identify the productivity potential across a hydrocarbon play. The system determines a correlation between historical cumulative production and well properties across the hydrocarbon play. Through utilization of Total Organic Content and thermal maturity, this correlation results in the calculation of a producibility index which is ultimately utilized to predict the production in new wells.

### FIELD OF THE INVENTION

The present invention relates generally to hydrocarbon reservoir analysis and, more specifically, to a system which predicts future well production and identifies productivity potential across a hydrocarbon play.

### BACKGROUND

In hydrocarbon exploration, accurately understanding the economic projections of a play is vitally important. Conventional approaches to such analysis have been theoretical in nature, and failed to provide data based upon actual historical production across the play. Standard theoretical approaches to estimating oil or gas production involve calculating Original Oil in Place (OOIP) or Original Gas in Place (OGIP), then multiplying by a recovery factor to arrive at Estimated Ultimate Recovery (EUR). OOIP and OGIP are calculated based on net thickness of the reservoir, porosity, hydrocarbon saturation, and oil or gas volume factors. However, this is approach is disadvantageous and introduces uncertainty into the estimation because it is purely theoretical and does not correlate with actual historical production data.

In view of the foregoing, there is a need in the art for a system to predict productivity based upon well properties and actual historical production across the play, thereby providing a more practical, reliable and accurate economic projection of the play.

### BRIEF DESCRIPTION OF THE DRAWINGS

FIG. 1 illustrates a block diagram of a well production prediction system according to certain exemplary embodiments of the present invention;

FIG. 2 illustrates a method for predicting well production across a defined hydrocarbon play according to certain exemplary methodologies of the present invention;

FIG. 3 is a graph illustrating the correlation between the Thermal Maturity Transform Factor and Vitrinite Reflectance (R_{O}), according to certain exemplary embodiments of the present invention;

FIG. 4 is a graph illustrating the cumulative production for a defined play vs. its final generation producibility index, according to certain exemplary embodiments of the present invention; and

FIG. 5 is a 2-Dimensional earth model that maps the predicted barrels of oil equivalent/lateral foot production along a defined hydrocarbon play, generated according to certain exemplary embodiments of the present invention.

### DESCRIPTION OF ILLUSTRATIVE EMBODIMENTS

Illustrative embodiments and related methodologies of the present invention are described below as they might be employed in a system which predicts future well production and identifies productivity potential across a play. In the interest of clarity, not all features of an actual implementation or methodology are described in this specification. Also, the “exemplary” embodiments described herein refer to examples of the present invention. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methodologies of the invention will become apparent from consideration of the following description and drawings.

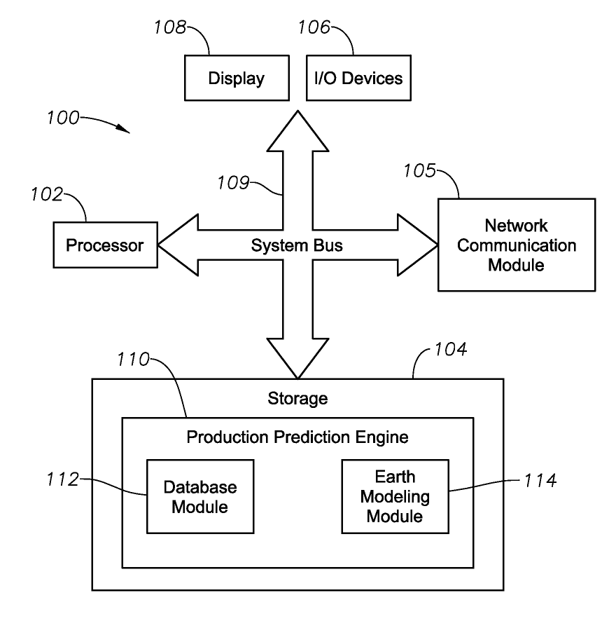

FIG. 1 shows a block diagram of a production prediction system 100 according to certain exemplary embodiments of the present invention. As will be described herein, exemplary embodiments of the present invention compare formation and well property data to actual production data in order to predict future production of a well and/or to identify the productivity potential across a hydrocarbon play. More specifically, the present invention determines a correlation between actual historical cumulative production of a wellbore in an organic-rich hydrocarbon reservoir and its formation and well properties. This correlation results in the calculation of a producibility index which is ultimately utilized to predict the production in new wells.

Referring to FIG. 1, exemplary production prediction system 100 includes at least one processor 102, a non-transitory, computer-readable storage 104, transceiver/network communication module 105, optional I/O devices 106, and an optional display 108 (e.g., user interface), all interconnected via a system bus 109. Software instructions executable by the processor 102 for implementing software instructions stored within production prediction engine 110 in accordance with the exemplary embodiments described herein, may be stored in storage 104 or some other computer-readable medium. Although not explicitly shown in FIG. 1, it will be recognized that production prediction system 100 may be connected to one or more public and/or private networks via one or more appropriate network connections. It will also be recognized that the software instructions comprising production prediction engine 110 may also be loaded into storage 104 from a CD-ROM or other appropriate storage media via wired or wireless methods.

Moreover, those ordinarily skilled in the art will appreciate that the invention may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present invention. The invention may be practiced in distributed-computing environments where tasks are performed by remote-processing devices that are linked through a communications network. In a distributed-computing environment, program modules may be located in both local and remote computer-storage media including memory storage devices. The present invention may therefore, be implemented in connection with various hardware, software or a combination thereof in a computer system or other processing system.

Still referring to FIG. 1, in certain exemplary embodiments, production prediction engine 110 comprises database module 112 and earth modeling module 114. Database module 112 provides robust data retrieval and integration of historical and real-time reservoir related data that spans across all aspects of the well planning, construction and completion processes such as, for example, drilling, cementing, wireline logging, well testing and stimulation. Moreover, such data may include, for example, open hole logging data, well trajectories, petrophysical rock property data, surface data, fault data, data from surrounding wells, data inferred from geostatistics, etc. The database (not shown) which stores this information may reside within database module 112 or at a remote location. An exemplary database platform is, for example, the INSITE® software suite, commercially offered through Halliburton Energy Services Inc. of Houston Tex. Those ordinarily skilled in the art having the benefit of this disclosure realize there are a variety of software platforms and associated systems to retrieve, store and integrate the well related data, as described herein.

Still referring to the exemplary embodiment of FIG. 1, production prediction engine 110 also includes earth modeling module 114 to integrate with the data contained within database module 112 in order to provide subsurface stratigraphic visualization including, for example, geo science interpretation, petroleum system modeling, geochemical analysis, stratigraphic gridding, facies, net cell volume, and petrophysical property modeling. Exemplary earth modeling platforms include, for example, DecisionSpace®, which is commercially available through the Assignee of the present invention, Landmark Graphics Corporation of Houston, Tex. However, those ordinarily skilled in the art having the benefit of this disclosure realize a variety of other earth modeling platforms may also be utilized with the present invention.

Moreover, production prediction engine 110 may also include multi-domain workflow automation capabilities that may connect any variety of desired technical applications. As such, the output from one application, or module, may become the input for another, thus providing the capability to analyze how various changes impact the well placement and/or fracture design. Those ordinarily skilled in the art having the benefit of this disclosure realize there are a variety of workflow platforms which may be utilized for this purpose.

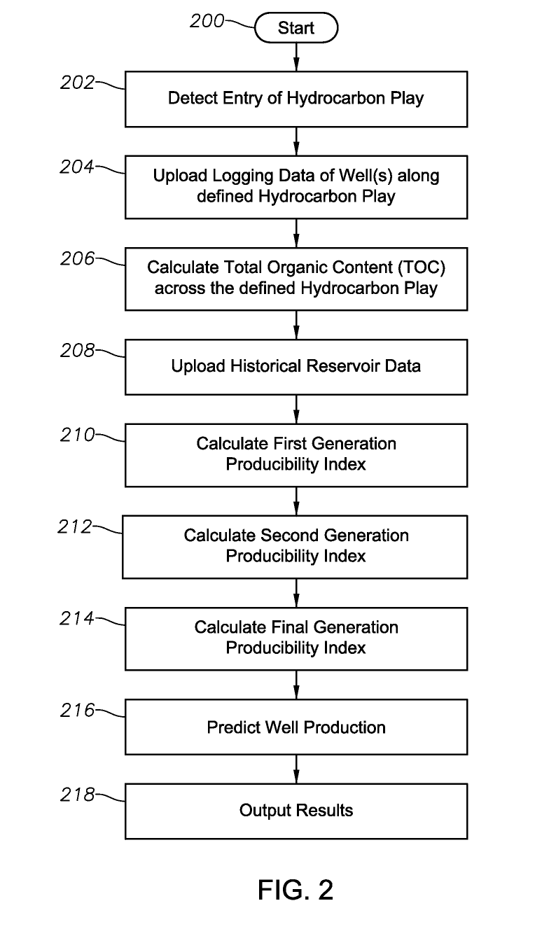

Referring to FIG. 2, exemplary methodologies of the present invention utilized to predict well production will now be described. Referring to method 200, at block 202, production prediction engine 110 detects entry of a defined hydrocarbon play to be simulated by earth modeling module 114. An exemplary play may be, for example, the Eagle Ford Shale. Such entry may be entered into a graphical user interface, for example, using a collection of coordinates that depict the geographical boundaries of the play along the surface and/or subsurface of the reservoir model, as understood in the art. Once defined, production prediction engine 110 will then utilize the defined play as the basis for the remainder of the analysis and simulation in which well production will be predicted.

At block 204, production prediction engine 110 uploads logging data obtained from one or more wells that have been drilled along the defined hydrocarbon play. This logging data may be obtained from database module 112 or some other remote location via network communication module 105. Such logging data may be, for example, open hole logging data reflecting various well properties including formation thickness and depth, in addition to standard formation/well properties including gamma ray, resistivity, porosity, sonic travel time—all used to derive further well properties, including TOC %. As described below, this logging data is utilized to determine trends and correlations between certain well properties and production.

At block 206, production prediction engine 110 utilizes the logging data to calculate the average Total Organic Content (“TOC”) across the defined hydrocarbon play. To do so, production prediction engine 110 may utilize a variety of TOC calculation techniques, such as, for example, Q. R. Passey's Delta LOG R technique to identify and calculate TOC % in organic-rich rocks. However, those ordinarily skilled in the art having the benefit of this disclosure is realize there are a variety of TOC calculation platforms which may be utilized. One such platform is the ShaleXpert^{SM} software suite, commercially offered through Halliburton Energy Services, Co. of Houston, Tex.

At block 208, production prediction engine 110 uploads historical reservoir related data for the defined hydrocarbon play from database module 112 or some remote source via network communication module 105. Such reservoir related data may include, for example, source rock thickness (“SRT”), wellbore lateral length (“WLL”) of one or more wells across the play, wellbore depth of one or more wells across the play, Vitrinite Reflectance (“R_{O}”) or other data related to various core values of petrophysical properties of the subsurface along the defined play. As understood in the art, such reservoir related data may be obtained from a number of publicly available sources, such as, for example, the Bureau of Economic Geology.

At block 210, production prediction engine 110 then calculates a first generation producibility index (“PI”) for the defined play. As described herein, the producibility index is the end result of mathematically combining each of the well properties in order to correlate to production, in order to thereby determine the correlation between the well properties and production. In one exemplary embodiment, to calculate the first generation producibility index, production prediction engine 110 utilizes the following:

1^{st} Gen. PI=TOC(%)×SRT(ft)×WLL(kft) Eq. (1),

As previously described, TOC (%) is the average weight % of Total Organic Content across the defined play, SRT (ft) is the source rock thickness across the defined play in feet, and WLL (kft) is the wellbore lateral length in in thousand feet.

The calculated first generation producibility index is then utilized by production prediction engine 110 to calculate the second generation producibility index at block 212. Here, the first generation producibility index must be multiplied by a Thermal Maturity Transform Factor (“TMTF”), which takes thermal maturity of the defined play into account. As understood in the art, thermal maturity refers to the degree of heating of the source rock in the process of transforming organic matter into hydrocarbons. To determine the Thermal Maturity Transform Factor, production prediction engine 110 utilizes the following known correlation:
R_{O}<0.45 is immature (i.e., no hydrocarbon generation).
0.45<R_{O}<1.5 is oil to liquid gas window.
R_{O}>1.5 is liquid gas to dry gas window.
R_{O}>2.2 is dry gas.
   This correlation will be readily understood by those ordinarily skilled in the art having the benefit of this disclosure.

However, in developing the present invention, a new correlation was discovered between production and thermal maturity. Through an historical analysis of the relationship between production and the first generation producibility index for a given play, it was discovered that thermal maturity plays a role in total production, which ultimately culminated in the development of the Thermal Maturity Transform Factor. During development of the present invention, the first generation producibility index was plotted vs. historical production. With the resulting plot, it was discovered that, as the first producibility index increased, production also increased linearly—up to a certain point, whereby the correlation then began to skew (was no longer linear). Based upon this, it was discovered that at more mature levels of R_{O}, production suffered for this specific play. Accordingly, the relationship between thermal maturity and production was discovered.

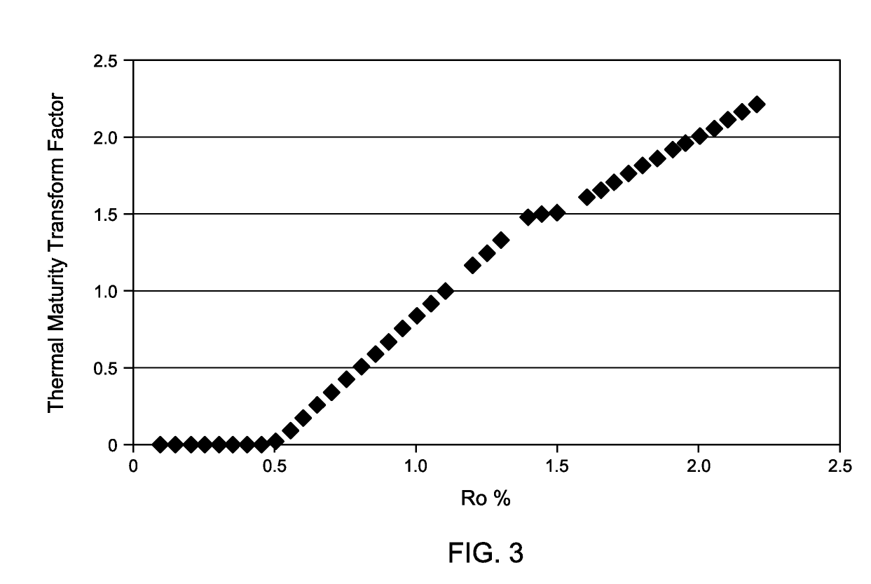

Thus, through the utilization of linear suppression, the Thermal Maturity Transform Factor was developed to represent the relationship between thermal maturity and cumulative production of the defined hydrocarbon play. Although the example given here applies to the Eagle Ford Shale, those ordinarily skilled in the art having the benefit of this disclosure realize this same technique may be applied to other hydrocarbon plays. FIG. 3 illustrates one exemplary embodiment of the Thermal Maturity Transform Factor. Here, the Thermal Maturity Transform Factor is plotted vs. R_{O}, in which it is found that:

TMTF for R_{O}<0.45=0 Eq. (2),

TMTF for 0.45<R_{O}<1.4=1.639344×(R_{O}−0.803279) Eq. (3),

TMTF for R_{O}>1.4=0.9125×0.2125 Eq. (4).

As a result of this calculation at block 212, production prediction engine 110 will output a Thermal Maturity Transform Factor in the range of 0-2. Thereafter, production prediction engine 110 will multiply the first generation producibility index by the Thermal Maturity Transform Factor in order to calculate the second generation producibility index at block 212.

At block 214, production prediction engine 110 then calculates the final generation producibility index. To do so, production prediction engine 110 must first determine the Depth Factor for the defined hydrocarbon play. By multiplying the second generation producibility index by the Depth Factor (“DF”), production prediction engine 110 takes depth of source rock into account. In other words, the Depth Factor reveals that if the well is drilled at X depth, the producibility index will be X. To determine the Depth Factor, production prediction engine 110 utilizes a polynomial suppression of historical producibility between determined well depths for the defined hydrocarbon play. For example, during testing of the present invention, depths of less than 8,000 feet were found to significantly decrease production within the Eagle Ford Shale. Therefore, in this example, production prediction engine 110 applies the following:

DF for Depth>8000 ft=1 Eq. (5),

DF for Depth<8000 ft=0.0000000121×Depth²−0.000057×Depth Eq. (6),

DF for Depth<4500 ft=0 Eq. (7).

As a result, a Depth Factor in the range of 0-1 will be calculated, and then multiplied by the second generation producibility index in order to calculate the final generation producibility index at block 214.

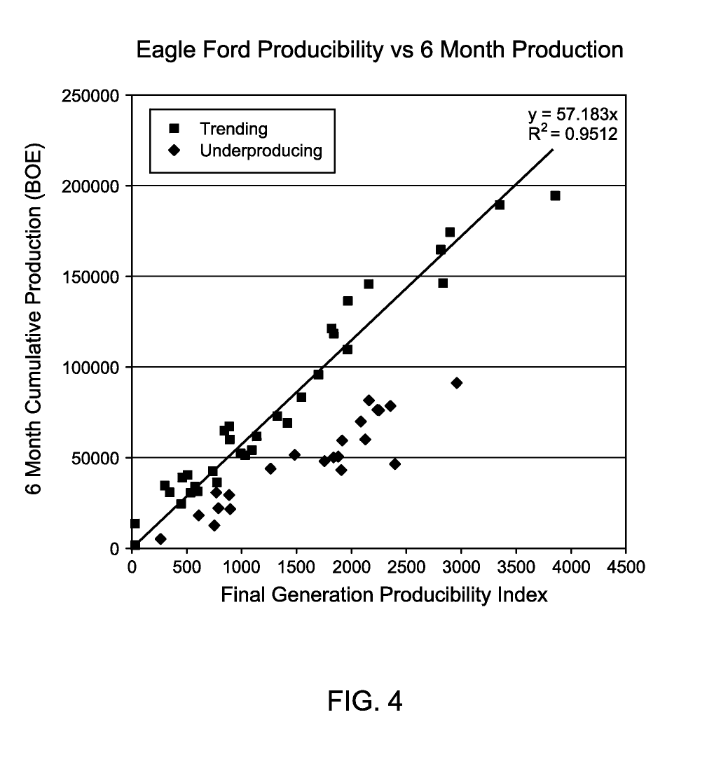

At block 216, production prediction engine 110 then predicts the well production over the defined hydrocarbon play. To do so, production prediction engine 110 first utilizes the final generation producibility index to determine the linear correlation between cumulative historical production within the defined play and the final generation producibility index, which is further described with reference to FIG. 4.

FIG. 4 plots the cumulative production for a defined play vs. its final generation producibility index determined at block 214. In this example, the Eagle Ford Shale is utilized, along with its 6-month cumulative Barrels of Oil Equivalent (“BOE”) production. However, in alternative embodiments, other hydrocarbon plays and historical cumulative production time periods may be applied. Through plotting of trending and underproducing wells as shown, production prediction engine 110 determined that the linear equation between the final generation producibility index and cumulative production for this defined play is y=57.183x, with the statistical coefficient of determination, or R², of the trendline being ˜0.95. It is hypothesized that those underproducing wells underproduce because they were either drilled out of zone or completed using a suboptimal technique. Nevertheless, new or future wells production may be predicted in the same manner. As described in more detail below, by calculating the final generation producibility index using actual or estimate lateral length, estimated production can be predicted by multiplying the final generation producibility index by the slope of the linear relationship described above.

Still referring to block 216, after the linear relationship has been calculated, production prediction engine may then calculates production for a given well in predicted BOE/Lateral feet or some other desired quantification. To do so in one example, production prediction engine 110 applies the following:

BOE=m×(Final Gen. P.I./WLL) Eq. (8),

with m representing the linear relationship between cumulative historical production and the final generation producibility index. In the example given above with reference to FIG. 4, y=57.183x. In the alternative, predicted BOE for a given well may also be represented as:

BOE=Final Gen P.I.×m Eq. (9).

In yet another exemplary methodology, to generate a map view in BOE/Lat. Ft., production prediction engine 110 applies the following:

BOE/Lat. Ft.=TOC%×SRT×TMTF×DF×(m/1000) Eq. (10).

Note also that in alternative embodiments, other quantitative units may also be utilized as desired, such as, for example, cubic feet of gas equivalent. Accordingly, production prediction engine 110 utilizes actual historical production and rock properties to predict future production.

Once the predicted BOE per lateral feet index has been calculated by production prediction engine 110 at block 216, production prediction engine 110 outputs the results at block 218. In one exemplary embodiment, utilizing earth modeling module 114 and taking into account the uploaded subsurface data of the defined play, production prediction engine 110 maps the predicted BOE/lateral feet index across the defined play to create a “sweet spot” map which allows an end user to predict production from the BOE/lateral feet index based on a target lateral length. Such an output model may be rendered in 2D or 3D.

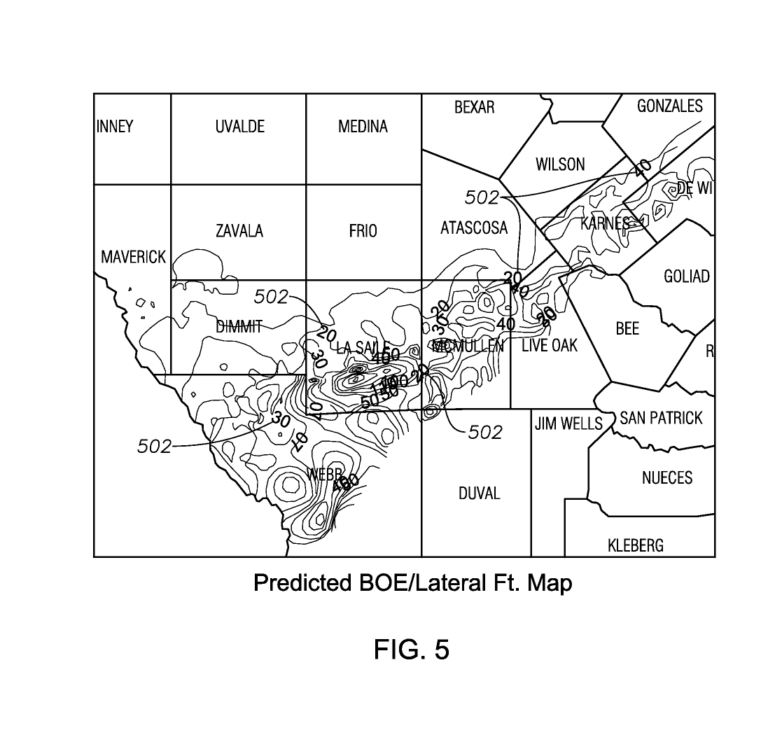

FIG. 5 illustrates an exemplary 2D “sweet spot” map plotting the predicted BOE/lateral foot production along the defined hydrocarbon play. As previously described, production prediction engine 110, via earth modeling module 114, has mapped the predicted BOEs 502 at is the predicted locations along the contour lines in the earth model. As shown, the map may also display counties, states, etc. which span across the defined play. Accordingly, utilizing the sweet spot map, the production of future wells drilled along the hydrocarbon play can be accurately predicted.

In certain other exemplary embodiments, production prediction engine 110, using earth modeling module 114, is adapted to display various maps of the petrophysical data described herein. Production prediction engine 110 utilizes the maps to run larger scale maps which populate areas between the wells used to create the model or expands the model to a much larger dataset. For example, production prediction engine 110 may map the source rock thickness, Total Organic Content, Vitrinite Reflectance of Depth over a defined hydrocarbon play. These and other variations of the present invention will be readily apparent to those ordinarily skilled in the art having the benefit of this disclosure.

The foregoing methods and systems described herein are particularly useful in planning, altering and/or drilling wellbores. As described, the system predicts well production for one or more wells over a defined hydrocarbon play. Thereafter, using the present invention, a well may be simulated, planned, or an existing wellbore may be altered in real-time and/or further operations may be altered. In addition, well equipment may be identified and prepared based upon the determined well placement, and the wellbore is drilled, stimulated, altered and/or completed in accordance to the determined well placement or stimulation plan.

The present invention provides a number of advantages. First, for example, operators may drill to frac in the optimum locations for maximum production along the hydrocarbon play. Second, having the advanced knowledge of expected production for a defined well, operators can better understand the economic value of a play and their expected return on investment.

An exemplary methodology of the present invention provides a method to predict well productivity within a hydrocarbon play, the method comprising determining a correlation between well properties and cumulative historical production across the hydrocarbon play; and predicting well productivity across the defined hydrocarbon play based upon the correlation. In other method, the correlation is a linear mathematical correlation between the well properties and the cumulative historical production. In yet another, determining the linear mathematical correlation further comprises representing the well properties as a producibility index, the producibility index being a mathematical combination of a plurality of well properties. In another, the plurality of well properties comprises at least one of a Total Organic Content, source rock thickness, wellbore lateral length, wellbore depth, or Vitrinite Reflectance. In yet another method, determining the correlation further comprises utilizing a Thermal Maturity Transform Factor which represents a relationship between thermal maturity and cumulative production across the defined hydrocarbon play.

In yet another method, determining the correlation further comprises representing the well properties as a final generation producibility index using the method comprising: calculating a Total Organic Content across the defined hydrocarbon play; calculating a first generation producibility index using the Total Organic Content; calculating a second generation producibility index using the first generation producibility index; and calculating the final generation producibility index using the second generation producibility index, wherein the final generation producibility index is a mathematical combination of a plurality of well properties. In another, calculating the second generation producibility index further comprises calculating a Thermal Maturity Transform Factor which represents a relationship between thermal maturity and cumulative production of the defined hydrocarbon play; and mathematically combining the Thermal Maturity Transform Factor with the first generation producibility index, thereby calculating the second generation producibility index.

In another exemplary methodology, calculating the final generation producibility index further comprises calculating a Depth Factor that represents a correlation between well depth and production across the defined hydrocarbon play; and mathematically combining the Depth Factor and the second generation producibility index, thereby calculating the final generation producibility index. In yet another, predicting the well productivity across the defined hydrocarbon play further comprises utilizing the final generation producibility index to determine a linear mathematical correlation between cumulative historical production along the defined hydrocarbon play and the final generation producibility index; and mathematically combining the linear mathematical correlation with the final generation producibility index, thereby predicting the well productivity across the defined hydrocarbon play. In another, the method further comprises generating a map that plots the predicted well productivity across the defined hydrocarbon play.

Furthermore, the exemplary methodologies described herein may be implemented by a system comprising processing circuitry or a computer program product comprising instructions which, when executed by at least one processor, causes the processor to perform any of the methodology described herein.

Although various embodiments and methodologies have been shown and described, the invention is not limited to such embodiments and methodologies and will be understood to include all modifications and variations as would be apparent to one skilled in the art. Therefore, it should be understood that the invention is not intended to be limited to the particular forms disclosed. Rather, the intention is to cover all modifications, equivalents and alternatives falling within the spirit and scope of the invention as defined by the appended claims.

1. A method to predict well productivity within a hydrocarbon play, the method comprising: determining a correlation between well properties and cumulative historical production across the hydrocarbon play; and
predicting well productivity across the defined hydrocarbon play based upon the correlation.

2. A method as defined in claim 1, wherein the correlation is a linear mathematical correlation between the well properties and the cumulative historical production.

3. A method as defined in claim 2, wherein determining the linear mathematical correlation further comprises representing the well properties as a producibility index, the producibility index being a mathematical combination of a plurality of well properties.

4. A method as defined in claim 3, wherein the plurality of well properties comprises at least one of a Total Organic Content, source rock thickness, wellbore lateral length, wellbore depth, or Vitrinite Reflectance.

5. A method as defined in claim 1, wherein determining the correlation further comprises utilizing a Thermal Maturity Transform Factor which represents a relationship between thermal maturity and cumulative production across the defined hydrocarbon play.

6. A method as defined in claim 1, wherein determining the correlation further comprises representing the well properties as a final generation producibility index using the method comprising:
calculating a Total Organic Content across the defined hydrocarbon play;
calculating a first generation producibility index using the Total Organic Content;
calculating a second generation producibility index using the first generation producibility index; and
calculating the final generation producibility index using the second generation producibility index, wherein the final generation producibility index is a mathematical combination of a plurality of well properties.

7. A method as defined in claim 6, wherein calculating the second generation producibility index further comprises:
calculating a Thermal Maturity Transform Factor which represents a relationship between thermal maturity and cumulative production of the defined hydrocarbon play; and
mathematically combining the Thermal Maturity Transform Factor with the first generation producibility index, thereby calculating the second generation producibility index.

8. A method as defined in claim 6, wherein calculating the final generation producibility index further comprises:
calculating a Depth Factor that represents a correlation between well depth and production across the defined hydrocarbon play; and
mathematically combining the Depth Factor and the second generation producibility index, thereby calculating the final generation producibility index.

9. A method as defined in claim 6, wherein predicting the well productivity across the defined hydrocarbon play further comprises:
utilizing the final generation producibility index to determine a linear mathematical correlation between cumulative historical production along the defined hydrocarbon play and the final generation producibility index; and
mathematically combining the linear mathematical correlation with the final generation producibility index, thereby predicting the well productivity across the defined hydrocarbon play.

10. A method as defined in claim 1, further comprising generating a map that plots the predicted well productivity across the defined hydrocarbon play.

11. A system comprising processing circuitry to implement the method in claim 1.

12. A computer program product comprising instructions which, when executed by at least one processor, causes the processor to perform the method in claim 1.
